(19) United States
(12) Patent Application Publication
(10) Pub. No.: US 2005/0032409 A1
(43) Pub. Date: Feb. 10, 2005

(54) IC socket

(76) Inventor: Shintaro Abe, Chiba (JP)

Correspondence Address: BARLEY SNYDER, LLC, 1000 WESTLAKES DRIVE, SUITE 275, BERWYN, PA, 19312, US

(21) Appl. No.: 10/911,113

(22) Filed: Aug. 4, 2004

(30) Foreign Application Priority Data
Aug. 5, 2003 (JP) 2003-287092

(51) Int. Cl. H01R 13/62

(52) U.S. Cl. 439/342

(57) ABSTRACT

A zero insertion force integrated circuit socket for receiving an integrated circuit package includes a housing, a cover, and a lever. The housing has an array of contacts arranged in a matrix. The cover is slideably attached to the housing. The lever has a crankshaft extending substantially perpendicular to an actuation shaft. The lever is rotatable between a horizontal position and a vertical position to slide the cover over an upper surface of the housing. The cover has first and second locking arms. The second locking arm has an outer arm section that extends substantially parallel to the first locking arm. The lever is received between the first locking arm and the outer arm section to lock the lever in the vertical position.

### FIELD OF THE INVENTION

The invention generally relates to zero insertion force (ZIF) integrated circuit (IC) sockets and, more particularly, to a ZIF IC socket having an actuation lever for attaching or detaching an IC package.

### BACKGROUND OF THE INVENTION

Integrated circuit (IC) sockets are traditionally used to electrically connect lead pins on an IC package to wiring on a circuit board. One type of IC socket, known as a zero insertion force (ZIF) socket, facilitates the attachment and detachment of the IC package to the wiring on the circuit board.

One example, of a ZIF IC socket has a lever that is actuated between a vertical and a horizontal position to attach or detach the IC package. When attaching the IC package to the IC socket, the IC package is mounted on a mounting surface of the IC socket with the lever in the vertical position. In this position, the lead pins on the IC package are accommodated in a space adjacent to a gap between a pair of resilient arms of contacts arranged in a matrix below the mounting surface. The gap has a larger diameter than the lead pins. As the lever is pushed downward toward the horizontal position, the mounting surface slides and each of the lead pins is inserted into the gap between the resilient arms to establish an electrical connection between each of the lead pins and the contacts. The distance between the resilient arms is smaller than a diameter of the lead pins. Since the arms are resilient, however, the lead pins on the IC socket can be inserted into or removed from the gaps between the resilient arms when the mounting surface slides. In this example, the IC package can be attached to the IC socket simply by mounting the IC package on the mounting surface and pushing down the lever. As a result, although the packaging density of the IC package and the number of lead pins on the IC package is large, the IC package does not require a large insertion force to insert the lead pins between the respective resilient arms of the contacts that are spaced apart by a distance smaller than the diameter of the lead pins.

When detaching the IC package from the IC socket, the lever is pulled upward from the horizontal position to the vertical position to remove the lead pins on the IC socket from the respective gaps between the resilient arms into the spaces described above, thus, breaking the electrical connection. During detachment of the IC package, the lead pins can be removed from the gaps between the respective resilient arms with only the force required to pull up the lever. The IC package can then be detached from the IC socket simply by lifting the IC package off the mounting surface with the lever being kept in the vertical position. A large pulling force is therefore not required to remove the lead pins from the gaps between the respective resilient arms.

Because this type of ZIF IC socket breaks the electrical connection between the lead pins and the contacts when the lever changes from the horizontal position to the vertical position, accidental breaks of the electrical connection can occur. To prevent the accidental break of the electrical connection, Japanese Utility Model Laid-Open No. 2-86088 and Japanese Utility Model Laid-Open No. 2-86089 teach an IC socket having a retaining protrusion that holds the lever in the horizontal position once the IC package is attached thereto. In the IC sockets described in the above-identified patent references, the lever may be moved to the horizontal position when the IC package is to be mounted or when the IC package is to be detached. If the lever is moved to the horizontal position, however, before the IC package is completely mounted, the lead pins on the IC package are misaligned and have to be housed in spaces which are closer to the arms and narrower than the spaces described above. As a result, a larger insertion force is required to insert the lead pins into the narrower spaces. Additionally, if the lever is moved to the horizontal position when the IC package is being removed from the mounting surface, the lead pins have to be drawn from the narrower spaces, which also requires a larger pulling force. Thus, because the lever can be accidentally moved from the vertical position to the horizontal position, the advantage of the ZIF-type IC socket cannot be taken advantage of.

### SUMMARY OF THE INVENTION

It is therefore an object of the invention is to provide an IC socket that facilitates mounting an IC package to the IC socket with an activation lever that attaches and detaches the IC package from the IC socket wherein the lever is secured in both a horizontal and a vertical position.

This and other objects are achieved by a zero insertion force integrated circuit socket for receiving an integrated circuit package including a housing, a cover, and a lever. The housing has an array of contacts arranged in a matrix. The cover is slideably attached to the housing. The lever has a crankshaft extending substantially perpendicular to an actuation shaft. The lever is rotatable between a horizontal position and a vertical position to slide the cover over an upper surface of the housing. The cover has first and second locking arms. The second locking arm has an outer arm section that extends substantially parallel to the first locking arm. The lever is received between the first locking arm and the outer arm section to lock the lever in the vertical position.

This and other objects are further achieved by a zero insertion force integrated circuit socket for receiving an integrated circuit package including a housing, a cover, and a lever. The housing has an array of contacts arranged in a matrix. The cover is slideably attached to the housing. A lever has a crankshaft extending substantially perpendicular to an actuation shaft. The lever is rotatable between a horizontal position and a vertical position to slide the cover over an upper surface of the housing. The cover has a first locking arm that locks the lever in the vertical position. The first locking arm is double-supported and formed to lock the actuation shaft at an end section close to the crankshaft.

### BRIEF DESCRIPTION OF THE DRAWINGS

FIG. 1 is a plan view of an IC socket showing a lever of the IC socket in a horizontal position;

FIG. 2 is a side view of the IC socket shown in FIG. 1;

FIG. 3 is a plan view of the IC socket showing the lever of the IC socket in a vertical position;

FIG. 4 is a side view of the IC socket shown in FIG. 3;

FIG. 5 is a plan view of the lever of the IC socket;

FIG. 6 is a left side view of the lever shown in FIG. 5;

FIG. 7 is a plan view of the IC socket of FIG. 1 shown with a cover of the IC socket removed;

FIG. 8 is a plan view of the IC socket of FIG. 3 shown with the cover of the IC socket removed;

FIG. 9 is a rear view of the cover shown from a side of a crank housing member; and

FIG. 10 is a partial cross sectional view of the cover taken along the line A-A′ of FIG. 9.

### DETAILED DESCRIPTION OF THE INVENTION

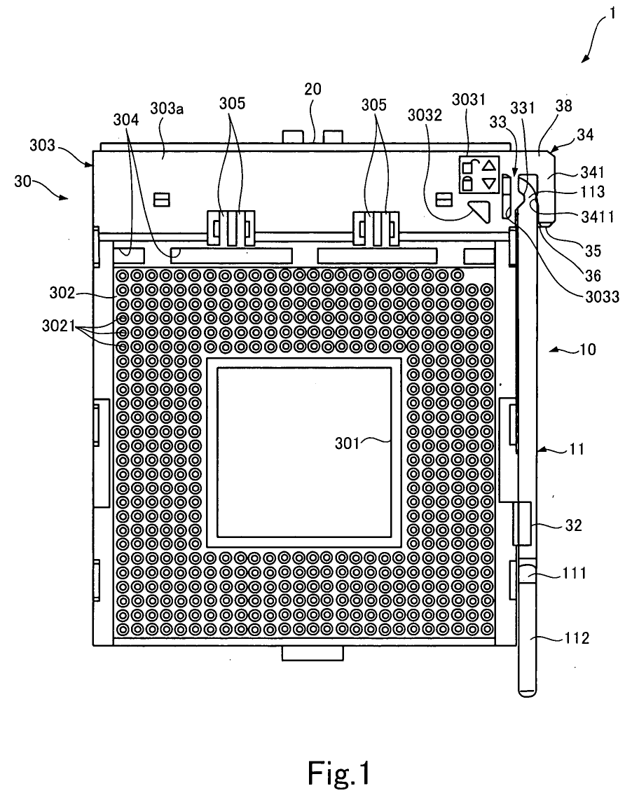

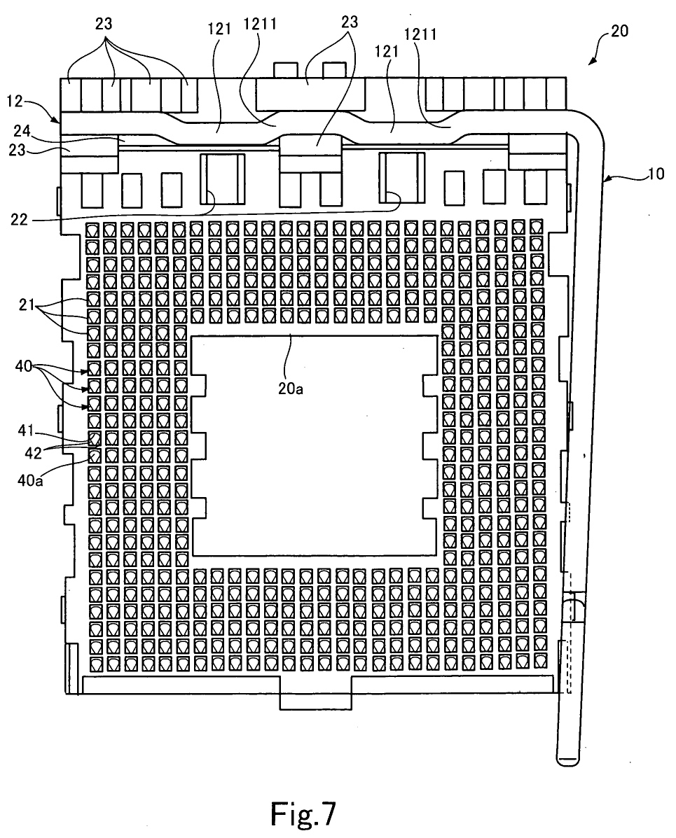

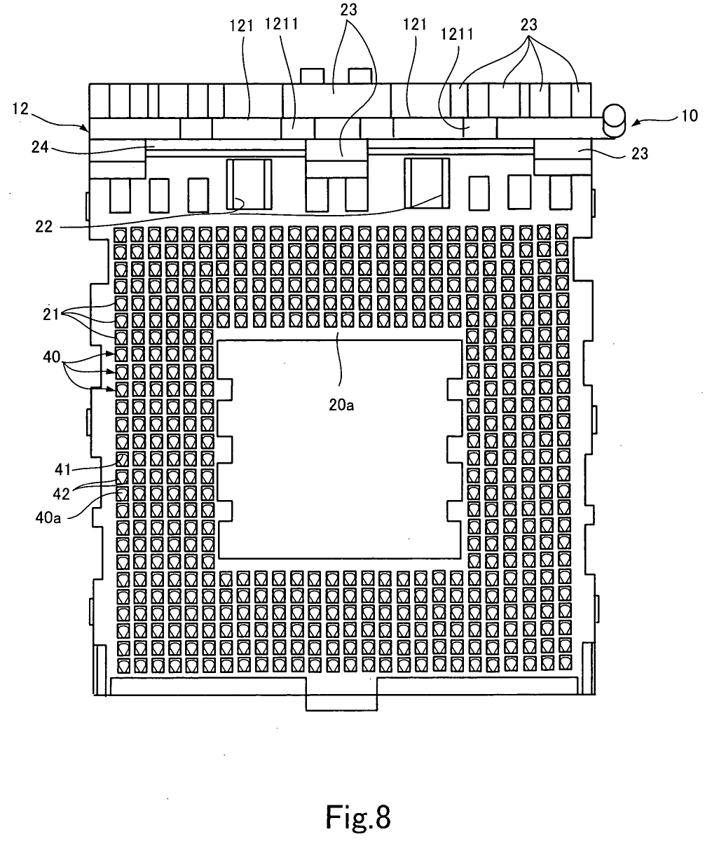

FIG. 1 shows a ZIF IC socket 1 according to an embodiment of the invention. The IC socket 1 has a housing 20, a cover 30, and a lever 10. A substantially rectangular opening 301 extends through an approximate center of the cover 30 and the housing 20. As shown in FIGS. 7 and 8, an upper surface 20a of the housing 20 has contact receiving cavities 21 arranged in a matrix. Each of the cavities 21 houses a contact 40. Each of the contacts 40 has a base portion 41. A pair of resilient arms 42 extend from ends of the base portion 41. Between the base portion 41 and distal ends of the resilient arms 42 is a space 40a that is large enough to accommodate the diameter of a lead pin (not shown) on an IC package (not shown). The distance between the distal ends of the resilient arms 42 is smaller than the diameter of the lead pin (not shown). The lead pin (not shown) on the IC package (not shown) is first inserted into the space 40a and then moved toward the distal ends of the resilient arms 42. In this position, the resiliency of the resilient arms 42 assure an electrical connection between the lead pin (not shown) and the contact 40.

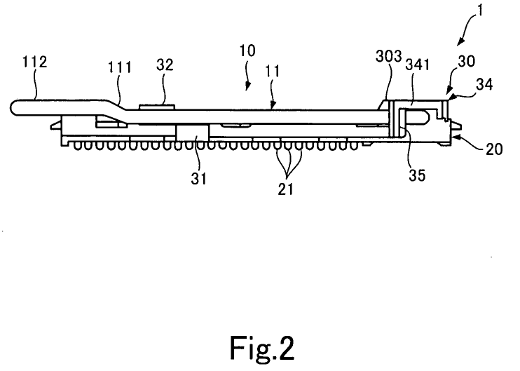

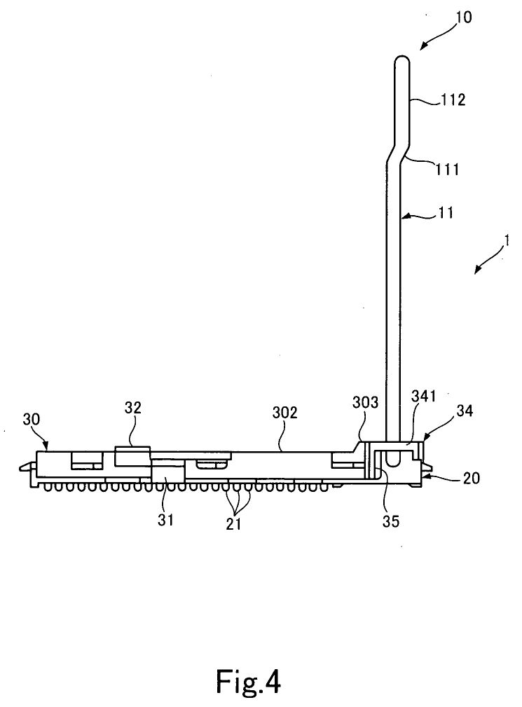

As shown in FIGS. 2 and 4, soldering balls 21 are provided on a bottom surface of the housing 20 in a one-to-one relationship with the contacts 40. The IC socket 1 is soldered to a surface of a circuit board (not shown) via the soldering balls 21. The housing 10 may be already fixed to the circuit board (not shown) when attaching or detaching the IC package (not shown).

As shown in FIGS. 7 and 8, retaining apertures 22 are formed on the housing 20 adjacent to the contacts 40. The retaining apertures 22 are formed to engage with a pair of retaining arms 305 on the cover 30, to be discussed later. A crank housing member 24 is formed adjacent to the retaining apertures 22. The crank housing member 24 has a plurality of projections 23 with varying heights.

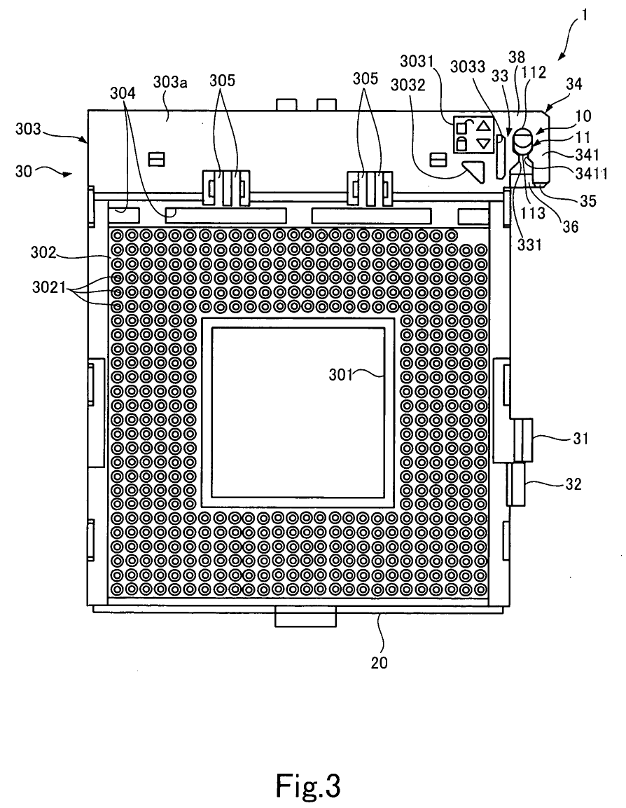

As shown in FIGS. 1 and 3, the cover 30 extends over the upper surface 20a of the housing 20. The cover 30 has a mounting surface 302 for mounting the IC package (not shown) surrounding the rectangular opening 301. The mounting surface 302 includes a plurality of through-holes 3021 for receiving the lead pins (not shown) of the IC package (not shown). At a right side of the mounting surface 302 is a receiving member 31 and a retaining protrusion 32. The receiving member 31 is disposed closer to a back side of the housing 20 than the retaining protrusion 32. As shown in FIGS. 2 and 4, a cover crank housing member 303 is formed at a height higher than the mounting surface 302. As shown in FIGS. 1 and 2, a front surface 303a of the cover housing member 303 has a pictorial illustration 3031 of the operation of the lever 10 and a positioning guide 3032 for correctly orienting the IC package (not shown).

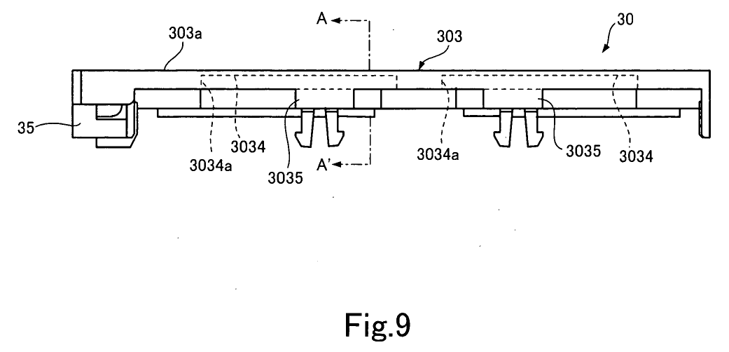

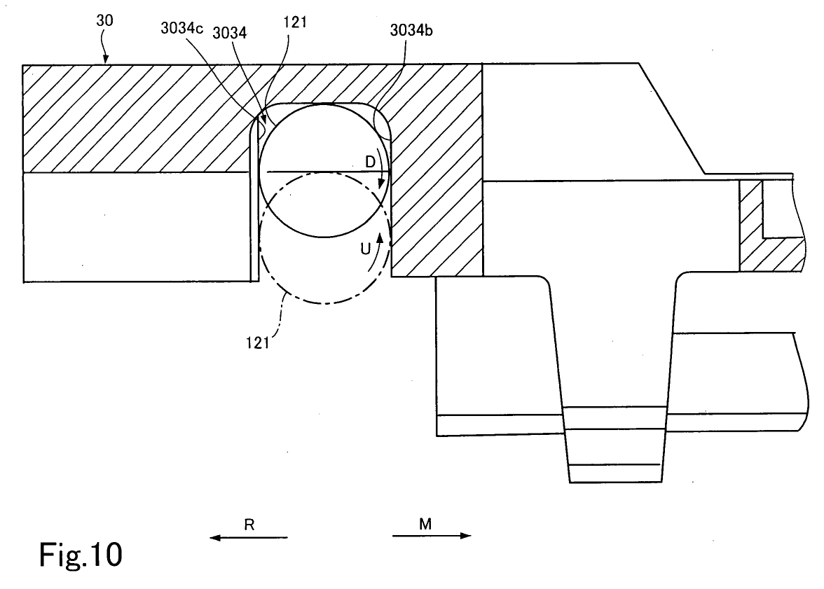

As shown in FIG. 9, a back surface of the cover housing member 303 has crank housing grooves 3034 recessed toward the front surface 303a of the cover 30. The crank housing grooves 3034 are horizontally spaced apart from each other and have end walls 3034a and side walls 3034b, 3034c, as best shown in FIGS. 9 and 10. Protrusions 3035 extend downward and away from the front surface 303a of the cover 30 close to the crank housing grooves 3034. Two pairs of the retaining arms 305 extend from the cover housing member 303 toward the retaining apertures 22. The retaining arms 305 are formed to retain the cover 30 on the housing 20 in a slidable manner.

As shown in FIGS. 1 and 3, a first locking arm 33 and a second locking arm 34 are formed on a right side of the cover housing member 303. The first locking arm 33 and the second locking arm 34 are provided in the same plane as the front surface 303a. The second locking arm 34 is substantially L-shaped when viewed from above and has an outer arm section 341 and a top arm section 38. The outer arm section 341 extends parallel to the first locking arm 33 and faces, from an outside, the first locking arm 33. The outer arm section 341 and the first locking arm 33 extend substantially parallel to an actuation shaft 11 of the lever 10 when the lever 10 is in a horizontal position, to be described later. As shown in FIGS. 1 and 3, a slit 3033 is formed in the cover housing member 303 parallel to the first locking arm 33 such that the first locking arm 33 has a double-supported beam structure. A second locking arm locking protrusion 3411 extends from the outer arm section 341. On a side opposite of the slit 3033, a first locking arm locking protrusion 331 extends toward the second locking arm locking protrusion 3411. The second locking arm locking protrusion 3411 is positioned lower than the first locking arm locking protrusion 331. The distance between a tip of the first locking arm locking protrusion 331 and a tip of the second locking arm locking protrusion 3411 is smaller than the diameter of an end section 113 of the lever 10, to be described later.

As best shown in FIGS. 2 and 4, a vertical arm 35 extends perpendicular to the plane of the surface 303a. One end of the second locking arm 34 is connected to the first locking arm 33 and the other end to the vertical arm 35. The vertical arm 35 extends substantially parallel to the actuation shaft 11 of the lever 10 when the lever 10 is in the vertical position, to be described later. The vertical arm 35 is connected to the cover housing member 303 by a linking arm 36, which is thinner than the first locking arm 33 and the second locking arm 34. The linking arm 36 is disposed closer to the housing 20 than a surface of the receiving member 31.

The cover 30 may be formed, for example, by resin molding. Because the difference in thickness between the cover housing member 303 and the mounting surface 302 may shrink the mounting surface 302 during resin molding, which could result in misalignment of the through-holes 3021, grooves 304 are formed in a row between the mounting surface 302 and the cover housing member 303 to reduce the difference in thickness.

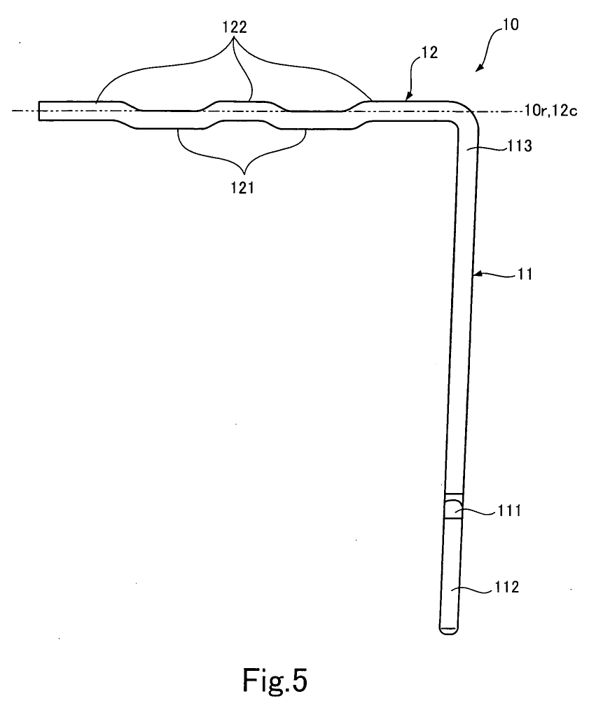

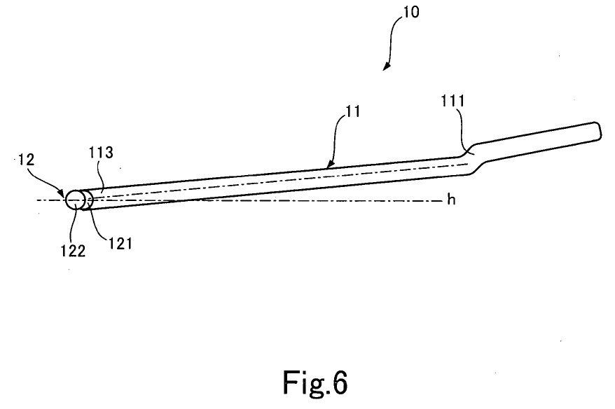

As shown in FIG. 5, the lever 10 is substantially L-shaped and includes the actuation shaft 11 and a crankshaft 12. The actuation shaft 11 extends substantially perpendicular to the crankshaft 12 and has an angled section 111 for facilitating the securement of a distal end section 112. The lever 10 has a rotation axis 10r that corresponds to a shaft center 12c of the crankshaft 12. The crankshaft 12 has first sections 121 displaced from the shaft center 12c and longitudinally spaced apart from each other. Between the first sections 121 and flanking the first sections 121 are second sections 122. The first sections 121 and the second sections 122 each have centers displaced by a slight angle from the shaft center 12c. As shown in FIG. 8, the first section 121 has steps 1211. As shown in FIG. 6, the second sections 122 and the first sections 121 lie in a horizontal plane h. The first sections 121 protrude to the upper right. The actuation shaft 11 extends from the end section 113 to the step 111 in the direction of the protruding first sections 121.

An operator can use the distal end section 112 to rotate the lever 10. When the lever 10 is rotated, the cover 30 slides over the housing 20. As the actuation shaft 11 of the lever 10 is pulled upward from the horizontal position shown in FIG. 1, the cover 30 slides in the upward direction in FIG. 1 to reach the state shown in FIG. 3. As the actuation shaft 11 of the lever 10 is pushed-downward from the vertical position shown in FIG. 3, the cover 30 slides in the downward direction in FIG. 3 to reach the state shown in FIG. 1.

As shown in FIGS. 1 and 3, the receiving member 31 and the retaining protrusion 32 retain the actuation shaft 11 in the horizontal position. The retaining protrusion 32 lies in the trajectory of the lever 10 and interferes with the actuation shaft 11 when the lever 10 is about to reach the horizontal position from the vertical position. In order for the lever 10 to reach the horizontal position, the actuation shaft 11 is pushed downward while the distal end section 112 is pulled outward to bend the actuation shaft 11 outward. This operation prevents interference between the actuation shaft 11 and the retaining protrusion 32 so that the actuation shaft 11 can be positioned below the retaining protrusion 32. Once this operation is completed, the actuation shaft 11 is received by the receiving member 31, which holds the lever 10 in the horizontal position shown in FIG. 1. The lever 10 is retained in the horizontal position and is prevented from rotating further, because the retaining protrusion 32 retains the lever 10 in the horizontal position from above to prevent it from being pulled upward, and the receiving member 31 retains the lever 10 from below to prevent it from being pushed further downward. The lever 10 can be rotated upward from the horizontal position to the vertical position by pulling the distal end section 112 of the actuation shaft 11 upward while pulling it outward, thereby releasing the actuation shaft 11 from the retaining protrusion 32.

As shown in FIGS. 7 and 8, the crankshaft 12 is rotatably housed between the cover housing member 303 of the cover 30 and the crank housing member 24 of the housing 20. The lever 10 can rotate about a center of the crankshaft 12 to change its position between the vertical position shown in FIG. 4 where the actuation shaft 11 stands substantially upright with respect to the surface of the circuit board (not shown) and the horizontal position shown in FIG. 2 where the actuation shaft 11 is substantially parallel to the surface of the circuit board (not shown).

As shown in FIG. 1, when the lever 10 is in the horizontal position, the end section 113 of the actuation shaft 11 close to the crankshaft 12 is located between the housing 20 and the vertical arm 35. Therefore, when the lever 10 is in the horizontal position, the vertical arm 35 faces, from the outside, the housing 20 with the end section 113 of the lever 10 interposed therebetween. Thus, the vertical arm 35 prevents the crankshaft 12 from dropping from between the housing 20 and the cover 30 with reliability when the lever 10 is in the horizontal position. Furthermore, when the lever 10 is in the vertical position as shown in FIG. 3, the end section 113 of the actuation shaft 11 is located between the first locking arm 33 and the outer arm section 341. Therefore, when the lever 10 is in the vertical position, the outer arm section 341 of the second locking arm 34 faces, from the outside, the first locking arm 33 with the end section 113 of the lever 10 interposed therebetween. Thus, the outer arm section 341 prevents the crankshaft 12 from dropping from between the housing 20 and the cover 30 with reliability when the lever 10 is in the vertical position.

As shown in FIG. 3, in the vertical position, the end section 113 of the lever 10 is retained, from both sides, by the first locking arm locking protrusion 331 on the first locking arm 33 and the second locking arm locking protrusion 3411 on the outer arm section 341. As the actuation shaft 11 of the lever 10 is pulled upward to rotate from the horizontal position to the vertical position, the end section 113 of the lever 10 comes into contact with the first locking arm locking protrusion 331 and the second locking arm locking protrusion 3411 when the lever 10 is about to reach the vertical position. As the actuation shaft 11 is rotated further, the end section 113 of the lever 10 temporarily widens the space between the tip of the first locking arm locking protrusion 331 and the tip of the second locking arm locking protrusion 3411. At this time, the first locking arm 33 is bent inward toward the slit 3033 and the space between the first locking arm locking protrusion 331 and the second locking arm locking protrusion 3411 is widened to reduce friction between the first locking arm locking protrusion 331 and the second locking arm locking protrusion 3411 and the end section 113 of the lever 10. The first locking arm locking protrusion 331 and the second locking arm locking protrusion 3411 are therefore formed to have a high durability. When the end section 113 of the lever 10 passes through the space between the first locking arm locking protrusion 331 and the second locking arm locking protrusion 3411, the lever 10 reaches the vertical position shown in FIG. 3. As the end section 113 of the lever 10 passes through the space between the first locking arm locking protrusion 331 and the second locking arm locking protrusion 3411, the operator feels a positive tactile response. Owing to the tactile response, the operator can tell when the lever 10 reaches the vertical position, which improves operability. In an alternate embodiment, either the first locking arm locking protrusion 331 or the second locking arm locking protrusion 3411 may be omitted.

As shown in FIG. 7, when the lever 10 in the horizontal position, the first sections 121 protrude toward the contacts 40. On the other hand, when the lever 10 is in the vertical position, as shown in FIG. 8, the first sections 121 protrude vertically with respect to a surface of the drawing and toward the crank housing 303 of the cover 30. The housing grooves 3034 house the first sections 121 of the lever 10 in the vertical position, as shown in FIG. 9.

The attachment and detachment of the IC package (not shown) to the IC socket 1 will now be described with reference to FIG. 10. In FIG. 10, the circle shown by the solid line represents a cross-section of the first section 121 of the lever 10 in the vertical position where about half of the crank section 121 is housed in the housing groove 3034. The circle shown by the alternate long and short dashed lines represents a cross-section of the first section 121 of the lever in the horizontal position.

To attach the IC package (not shown) to the IC socket 1 according to this embodiment, the lever 10 is first positioned in the vertical position, as shown in FIGS. 3 and 8. In the vertical position, the first sections 121 of the lever 10 are positioned between the crank housing grooves 3034 in the cover 30 and the crank housing member 24 in the housing 20. The step 1211 of the first section 121 is positioned closer to the actuation shaft, as shown in FIG. 8, and is engaged with the end wall 3034a of the housing groove 3034, which is closer to the vertical arm 35, as shown in FIG. 9, to prevent the crankshaft 12 from falling off the cover 30. Because the step 1211 is smoothly inclined and cannot solely prevent the crankshaft 12 from falling off, the outer arm section 341 further holds the crankshaft 12 in the cover 30. The end section 113 of the lever 10 in the vertical position is retained, from the both sides, by the first locking arm locking protrusion 331 and the second locking arm locking protrusion 3411, so that the lever 10 is held in the vertical position.

The IC package (not shown) is mounted on the mounting surface 302 of the IC socket 1 according to the positioning guide 3032. The lead pins (not shown) on the IC package (not shown) are inserted into the through-holes 3021 in the mounting surface 302 such that the lead pins (not shown) are received in the spaces 40a in the contacts 40, as shown in FIG. 8. Since the spaces 40a are large enough to accommodate the diameter of the lead pins (not shown) on the IC package (not shown), the IC socket 1 according to this embodiment does not require a great insertion force to mount the IC package (not shown). The lever 10 is then pushed downward from the vertical position. As the end section 113 of the lever 10 passes through the space between the first locking arm locking protrusion 331 and the second locking arm locking protrusion 3411, the operator feels a positive tactile response.

As the lever 10 is pushed downward, the crankshaft 12 rotates about the shaft center 12c and the first sections 121 move from the position shown in FIG. 8 to the position shown in FIG. 7. The rotation of the crankshaft 12 and the first sections 121 when the lever is pushed downward is indicated by arrow D in FIG. 10. During rotation, each of the first sections 121 press against the side wall 3034b of the housing groove 3034 closer to the mounting surface 302. Pressed by the first sections 121, the cover 30 slides in a direction indicated by arrow M in FIG. 10, so that the lead pins (not shown) inserted in the through-holes 3021 in the mounting surface 302 move toward the respective pairs of resilient arms 42 of the contacts 40, as shown in FIG. 8. When the actuation shaft 11 reaches the retaining protrusion 32, as best shown in FIG. 3, the actuation shaft 11 is bent outward to avoid the retaining protrusion 32 and pushed downward to position the actuation shaft 11 between the retaining protrusion 32 and the receiving part 31. When the actuation shaft 11 is between the retaining protrusion 32 and the receiving part 31, the lever 10 is in the horizontal position, and each of the lead pins (not shown) on the IC package (not shown) are resiliently held by the pair of resilient arms 42 of the contacts 40, as shown in FIG. 8.

When the lever 10 is in the horizontal position, the first sections 121 are located out of the crank housing grooves 3034, as indicated by the alternate long and short dashed lines in FIG. 10. The step 1211 of the first section 121 in the state shown in FIG. 7 is far from the actuation shaft 11 and is engaged with the protrusion 3035 shown in FIG. 9. The vertical arm 35 prevents the crank shaft 12 from falling off the cover 30. The lever 10 is prevented from rotating from the horizontal position by the retaining protrusion 32 and by the receiving part 31.

To detach the IC package (not shown) from the IC socket 1 according to this embodiment, the lever 10 is pulled upward from the horizontal position to the vertical position. To change the position of the lever 10 from the horizontal position to the vertical position, the actuation shaft 11 can be pulled upward and bent outward to avoid the retaining protrusion 32. As the lever 10 is pulled up, the crankshaft 12 rotates about the shaft center 12c and the first sections 121 move from the positions shown in FIG. 7 to the position shown in FIG. 8. The rotation of the crankshaft 12 and the first sections 121 during movement of the lever 10 from the horizontal position to the vertical position is indicated by arrow U in FIG. 10. During rotation, each of the first sections 121 press against the side wall 3034c of the housing groove 3034 far from the mounting surface 302. Pressed by the crank sections 121, the cover 30 slides in a direction indicated by arrow R in FIG. 10, and the lead pins (not shown) held between the respective pairs of resilient arms 42 of the contacts 40 move toward the spaces 40a, which are large enough to accommodate the diameter of the lead pins (not shown). When the lever 10 is about to reach the vertical position, the end section 113 of the lever 10 passes through the space between the first locking arm locking protrusion 331 and the second locking arm locking protrusion 3411. As the end section 113 of the lever 10 passes through the space between the first locking arm locking protrusion 331 and the second locking arm locking protrusion 3411, the operator feels a positive tactile response that indicates the lever 10 is in the vertical position. Since the first locking arm 33 has a double-supported-beam structure, the slit 3033 allows the first locking arm 33 to temporarily retract when the end section 113 is engaged with the first locking arm 33. Therefore, the first locking arm 33 pressed by the end section 113 is bent toward the slit 3033 to reduce friction between the end section 113 and the first locking arm 33, and the durability of the first locking arm 33 is improved. Once the lever 10 reaches the vertical position, the lead pins (not shown) are positioned in the spaces 40a which are large enough to accommodate the diameter of the lead pins (not shown). Since the end section 113 of the lever 10 is retained by the first locking arm locking protrusion 331 and the second locking arm locking protrusion 3411 in the vertical position, the IC package (not shown) can be lifted off the mounting surface 302. Because the lead pins (not shown) on the IC package (not shown) are released from the pairs of resilient arms 42 of the contacts 40, removing the IC package (not shown) from the mounting surface does not require a large pulling force.

1. An integrated circuit socket, comprising:
a housing having an array of contacts arranged in a matrix;
a cover slideably attached to the housing;
a lever having a crankshaft extending substantially perpendicular to an actuation shaft, the lever being rotatable between a horizontal position and a vertical position to slide the cover over an upper surface of the housing; and
the cover having first and second locking arms, the second locking arm having an outer arm section extending substantially parallel to the first locking arm, the lever being receivable between the first locking arm and the outer arm section to lock the lever in the vertical position.

2. The integrated circuit socket of claim 1, wherein the cover has a slit formed adjacent to the first locking arm such that the first locking arm retracts when the lever is received between the first locking arm and the outer arm section.

3. The integrated circuit socket of claim 1, further comprising at least one protrusion formed on the first locking arm or the outer arm section for engaging the lever when the lever is received therebetween.

4. The integrated circuit socket of claim 3, wherein when the lever is received between the first locking arm and the outer arm section there is a tactile response.

5. The integrated circuit socket of claim 1, further comprising a first locking arm locking protrusion formed on the first locking arm and a second locking arm locking protrusion formed on the outer arm section, the first locking arm locking protrusion and the second locking arm locking protrusion extending toward each other and engageable with the lever when the lever is received between the first locking arm and the outer arm section.

6. The integrated circuit socket of claim 5, wherein when the lever is received between the first locking arm and the outer arm section there is a tactile response.

7. The integrated circuit socket according to claim 1, wherein the cover includes a vertical arm extending substantially perpendicular to the outer arm section, the actuation shaft being disposed between the vertical arm and the housing when the lever is in the horizontal position.

8. The integrated circuit socket according to claim 1, further comprising a receiving member and a retaining protrusion, the receiving member being disposed closer to a back side of the housing than the retaining protrusion, the actuation shaft being disposed between the receiving member and the retaining protrusion when the lever is in the horizontal position.

9. The integrated circuit socket according to claim 1, wherein the cover has a crank housing groove recessed toward a front surface of the cover for receiving the crankshaft.

10. The integrated circuit socket according to claim 9, wherein the housing has a crank housing member for receiving the crankshaft.

11. An integrated circuit socket, comprising:
a housing having an array of contacts arranged in a matrix;
a cover slideably attached to the housing;
a lever having a crankshaft extending substantially perpendicular to an actuation shaft, the lever being rotatable between a horizontal position and a vertical position to slide the cover over an upper surface of the housing; and
the cover having a first locking arm that locks the lever in the vertical position, the first locking arm being double-supported and formed to lock the actuation shaft at an end section close to the crankshaft.

12. The integrated circuit socket of claim 11, further comprising a second locking arm having an outer arm section extending substantially parallel to the first locking arm such that the actuation shaft is received therebetween.

13. The integrated circuit socket of claim 12, wherein the cover has a slit formed adjacent to the first locking arm such that the first locking arm retracts when the lever is received between the first locking arm and the outer arm section.

14. The integrated circuit socket of claim 12, further comprising at least one protrusion formed on the first locking arm or the outer arm section for engaging the lever when the lever is received therebetween.

15. The integrated circuit socket of claim 14, wherein when the lever is received between the first locking arm and the outer arm section there is a tactile response.

16. The integrated circuit socket of claim 12, further comprising a first locking arm locking protrusion formed on the first locking arm and a second locking arm locking protrusion formed on the outer arm section, the first locking arm locking protrusion and the second locking arm locking protrusion extending toward each other and engageable with the lever when the lever is received between the first locking arm and the outer arm section.

17. The integrated circuit socket of claim 16, wherein when the lever is received between the first locking arm and the outer arm section there is a tactile response.

18. The integrated circuit socket according to claim 11, wherein the cover includes a vertical arm extending substantially perpendicular to the cover, the actuation shaft being disposed between the vertical arm and the housing when the lever is in the horizontal position.

19. The integrated circuit socket according to claim 11, further comprising a receiving member and a retaining protrusion, the receiving member being disposed closer to a back side of the housing than the retaining protrusion, the actuation shaft being disposed between the receiving member and the retaining protrusion when the lever is in the horizontal position.

20. The integrated circuit socket according to claim 11, wherein the cover has a crank housing groove recessed toward a front surface of the cover for receiving the crankshaft and the housing has a crank housing member for receiving the crankshaft.
